(19) United States
(12) Patent Application Publication
(10) Pub. No.: US 2011/0242026 A1
(43) Pub. Date: Oct. 6, 2011

(54) ELECTRONIC APPARATUS AND SEARCH CONTROL METHOD

(75) Inventor: Satoru ISHIGAKI, Ome-shi (JP)

(73) Assignee: KABUSHIKI KAISHA TOSHIBA, Tokyo (JP)

(21) Appl. No.: 13/053,001

(22) Filed: Mar. 21, 2011

(30) Foreign Application Priority Data
Mar. 31, 2010 (JP) 2010-083792

(51) Int. Cl. G06F 3/041; G09G 5/00

(52) U.S. Cl. 345/173; 345/1.3

(57) ABSTRACT

According to one embodiment, an electronic apparatus includes an acquisition module, an output module, an input module, and a search result display. The acquisition module is configured to acquire information indicative of an object designated on a first screen displayed by a program. The output module is configured to output to a search process module a search request relating to the information. The input module is configured to input a search result by the search process module in connection with the search request. The search result display is configured to display the search result on a second screen.

### CROSS-REFERENCE TO RELATED APPLICATIONS

This application is based upon and claims the benefit of priority from Japanese Patent Application No. 2010-083792, filed Mar. 31, 2010, the entire contents of which are incorporated herein by reference.

### FIELD

Embodiments described herein relate generally to an electronic apparatus and a search control method, which search information.

### BACKGROUND

Conventionally, there is known an electronic apparatus in which the operability is improved and the usability is enhanced by providing a first display module (first liquid crystal panel) and a second display module (second liquid crystal panel) (Jpn. Pat. Appln. KOKAI Publication No. 2008-117158). In this electronic apparatus, for example, when a description display screen is displayed on the first liquid crystal panel, a transition-destination select screen is automatically displayed on the second liquid crystal panel. The transition-destination select screen displays buttons of “New search”, “Search by other dictionary” and “Display list”. For example, when the button of “New search” has been selected, a character input field on a dictionary search input screen, which is displayed on the first liquid crystal panel, is cleared, and the display on the second liquid crystal panel is switched to a handwriting input screen, thus making a transition to the state in which a new character input is enabled.

In the conventional art, as described above, in the electronic apparatus that is capable of dual-screen display, the menu corresponding to an item displayed on the first liquid crystal panel is displayed on the second liquid crystal panel, thereby enhancing the operability. Specifically, even in an electronic apparatus with a small display screen, a function which is necessary in accordance with the current processing condition can easily be selected by displaying only the menu corresponding to the first display panel on the second liquid crystal panel.

However, in the conventional dual-screen display, only the first liquid crystal panel displays a current process result, for example, an explanatory passage extracted from the dictionary in connection with input characters. Thus, in order to compare explanatory passages which are displayed on the first liquid crystal panel in connection with different character inputs, the explanatory passage displayed on the first liquid crystal panel has to be repeatedly switched by manipulating buttons displayed on the second liquid crystal panel.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary external appearance view showing the structure of an electronic apparatus in an embodiment;

FIG. 2 is an exemplary block diagram showing a system configuration of a personal computer in the embodiment;

FIG. 3 is an exemplary view showing an example of the relationship between programs relating to touch panels in the embodiment;

FIG. 4 is an exemplary block diagram showing the functional structure of a search control application program in the embodiment;

FIG. 5 is an exemplary view showing a display example in a case where the search control application program and a browser program in the embodiment are executed;

FIG. 6 is an exemplary flow chart illustrating a browser process by the browser program in the embodiment;

FIG. 7 is an exemplary flow chart illustrating a search control process by the search control application program in the embodiment;

FIG. 8 is an exemplary flow chart illustrating a customizing process by the search control application program in the embodiment; and

FIG. 9 is an exemplary view showing an example of a setup screen which is displayed by the customizing process in the embodiment.

### DETAILED DESCRIPTION

Various embodiments will be described hereinafter with reference to the accompanying drawings.

In general, according to one embodiment, an electronic apparatus comprises an acquisition module, an output module, an input module, and a search result display. The acquisition module is configured to acquire information indicative of an object designated on a first screen displayed by a program. The output module is configured to output to a search process module a search request relating to the information. The input module is configured to input a search result by the search process module in connection with the search request. The search result display is configured to display the search result on a second screen.

An embodiment will now be described with reference to the accompanying drawings.

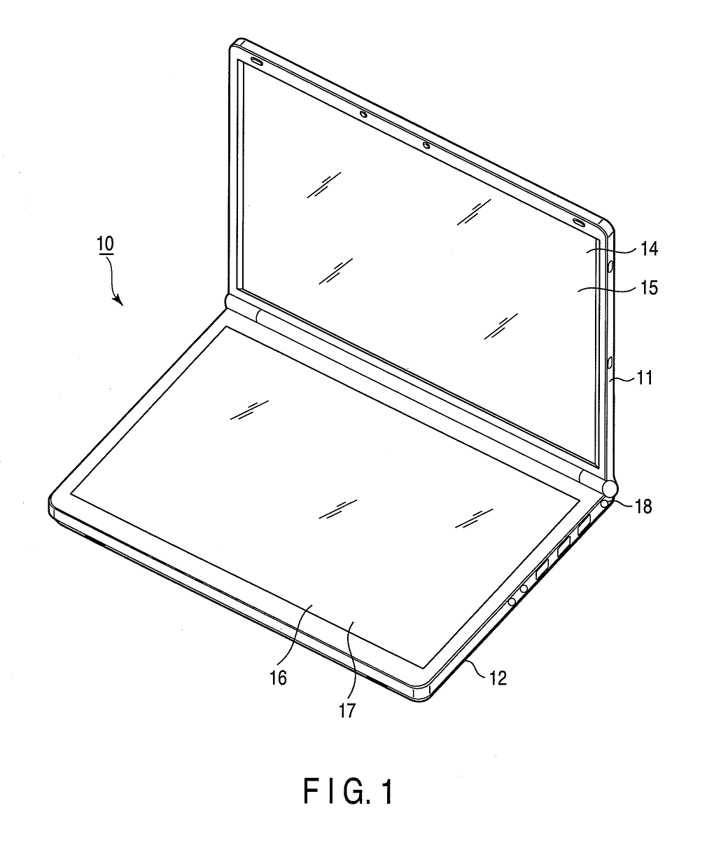

FIG. 1 is an exemplary external appearance view showing the structure of an electronic apparatus according to an embodiment. This electronic apparatus is realized, for example, as a notebook-type portable personal computer 10.

FIG. 1 is an exemplary perspective view showing the personal computer 10 in a state in which a first display unit 11 of the personal computer 10 is opened. The personal computer 10 comprises the first display unit 11 and a second display unit 12.

The first display unit 11 is configured to be rotatable between an open position and a closed position, relative to the second display unit 12, via a hinge mechanism. The hinge mechanism can set, for example, the angle between the first display unit 11 and the second display unit 12 at 180° so that the first display unit 11 and the second display unit 12 are disposed in a flat shape. Thereby, the first display unit 11 and the second display unit 12 can be placed on a table, etc., and can be used like a single touch panel.

A touch screen display, which is composed of a liquid crystal display (LCD) 14 and a touch panel 15, is built on an upper surface of the first display unit 11. The display screen of the touch screen display is positioned at a substantially central part of the first display unit 11.

The touch screen display is configured, for example, such that the touch panel 15 is mounted on the surface of the LCD 14, and can realize display by the LCD 14 and detection of a touch position which is touched by a pen or finger. The user can select, by using the fingertip or pen, various objects (icons representing folders and files, menus, buttons, characters, images, etc.) which are displayed on the LCD 14. The coordinate data indicative of a touch position on the display screen is input from the touch panel 15 to the CPU in the personal computer 10.

The second display unit 12 is a base unit having a thin box-shaped housing. The second display unit 12 is a computer main body, and principal units are mounted in the housing of the second display unit 12. A touch screen display, which is composed of a liquid crystal display (LCD) 16 and a touch panel 17, is built on an upper surface of the second display unit 12. The display screen of the touch screen display is positioned at a substantially central part of the second display unit 12.

The touch screen display is configured, for example, such that the touch panel 17 is mounted on the surface of the LCD 16, and can realize display by the LCD 16 and detection of a touch position which is touched by the pen or finger. Like the touch screen display provided on the first display unit 11, the user can select, by using the fingertip or pen, various objects (icons representing folders and files, menus, buttons, characters, images, etc.) which are displayed on the LCD 16. The coordinate data indicative of a touch position on the display screen is input from the touch panel 17 to the CPU in the personal computer 10.

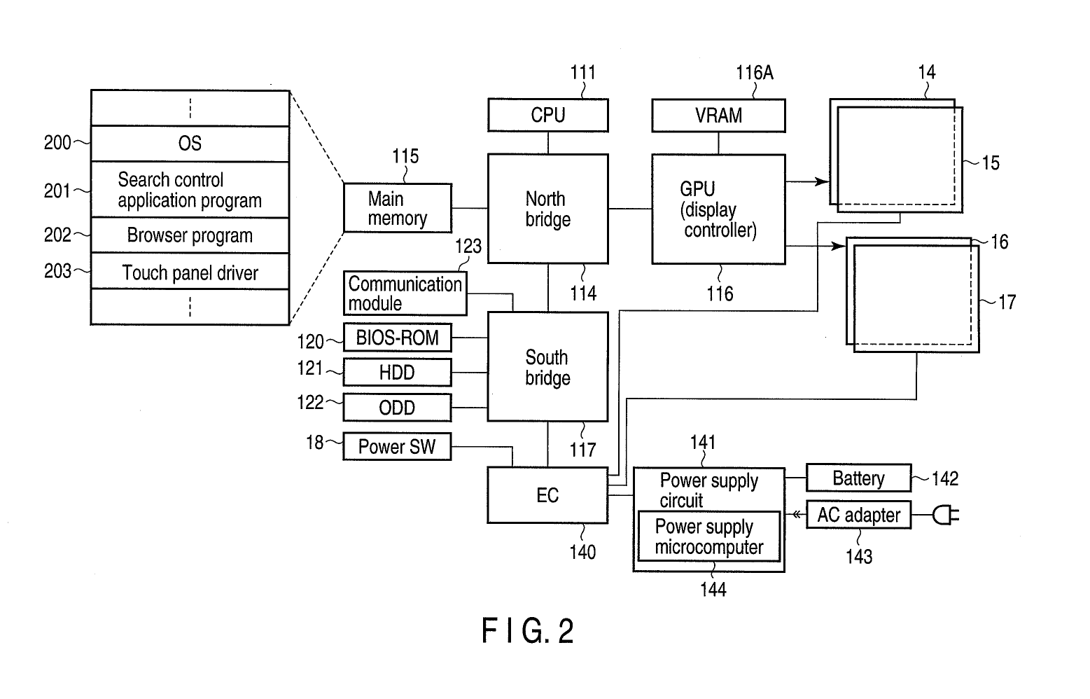

A side surface of the second display unit 12 is provided with a power button switch 18 for power-on/off, and various terminals. A battery 142 (shown in FIG. 2) is detachably attached to the bottom part of the second display unit 12. The second display unit 12 is provided with a power connector (not shown) to which an AC adapter 143 (shown in FIG. 2) can be connected.

The LCD 14 on the first display unit 11 and the LCD 16 on the second display unit 12 are independent displays. The LCDs 14 and 16 are usable as a multi-display for realizing a virtual screen environment. In this case, a virtual screen, which is managed by the operating system of the personal computer 10, includes a first screen region which is displayed on the LCD 14 and a second screen region which is displayed on the LCD 16. A display screen (window), an arbitrary object, etc., which are displayed by an arbitrary application program, can be displayed on each of the first screen region and second screen region.

FIG. 2 is an exemplary block diagram showing the system configuration of the personal computer 10 in the embodiment.

As shown in FIG. 2, the personal computer 10 includes a CPU 111, a north bridge 114, a main memory 115, a graphics processing unit (GPU) 116, a south bridge 117, a BIOS-ROM 120, a hard disk drive (HDD) 121, an optical disc drive (ODD) 122, a communication module 123, an embedded controller IC (EC) 140, and a power supply circuit 141.

The CPU 111 is a processor which is provided in order to control the operation of the personal computer 10. The CPU 111 executes an operating system (OS) 200 and various application programs, which are loaded from the HDD 121 into the main memory 115. The application programs include various programs which display character strings, such as a search control application program 201 and a browser program 202. The search control application program 201 executes screen display on a display (e.g. LCD 16) which is different from a display (e.g. LCD 14) on which a process content by an application such as the browser program 202 is displayed. In addition, the search control application program 201 outputs a search request to a search process module which executes a search process, based on an object (character, image, etc.) designated by the user in the screen (first screen) of the LCD 14 which is displayed by an application such as the browser program 202, and inputs a search result and displays the search result on the screen (second screen) of the LCD 16. Examples of the search process module include a search site (search engine) which is made public on the Internet, a program having a search function installed in the personal computer 10, etc. In addition, the CPU 111 executes a touch panel driver 203 and controls an input from the touch panel 15, 17. Further, the CPU 111 also executes a system BIOS (Basic Input/Output System) which is stored in the BIOS-ROM 120. The system BIOS is a program for hardware control.

The north bridge 114 is a bridge device which connects a local bus of the CPU 111 and the south bridge 117. The north bridge 114 includes a memory controller which access-controls the main memory 115.

The GPU 116 is a display controller which controls the LCDs 14 and 16 which are used as a display monitor of the personal computer 10. The GPU 116 executes a display process (graphics arithmetic process) for rendering frames on a video memory (VRAM) 116A, based on a rendering request which is sent from CPU 111 via the north bridge 114.

The south bridge 117 incorporates an IDE (Integrated Drive Electronics) controller and a Serial ATA controller for controlling the HDD 121 and optical disc drive (ODD) 122.

Under the control of the OS 200 (search control application program 201, browser program 202), the communication module 123 controls communication via a network with various sites (including a search engine) which are made public on the Internet.

The embedded controller IC (EC) 140 is a one-chip microcomputer in which a controller for power management and a controller for controlling the touch panels 15 and 17 are integrated. The EC 140 has a function of powering on/off the personal computer 10 in response to the user's operation of the power button switch 18. The power-on/off control of the personal computer 10 is executed by the cooperation between the EC 140 and power supply circuit 141.

The power supply circuit 141 generates operation power to the respective components by receiving power from the battery 142 which is attached to the second display unit 12, or power from an external power supply which is connected via the AC adapter 143. The power supply circuit 141 is provided with a power supply microcomputer 144. The power supply microcomputer 144 monitors the power supply (charge/discharge) to the respective components and battery 142, and the charging state of the battery 142. When the battery 142 and AC adapter 143 are connected, the power supply circuit 141 charges the battery 142 by the external power supply.

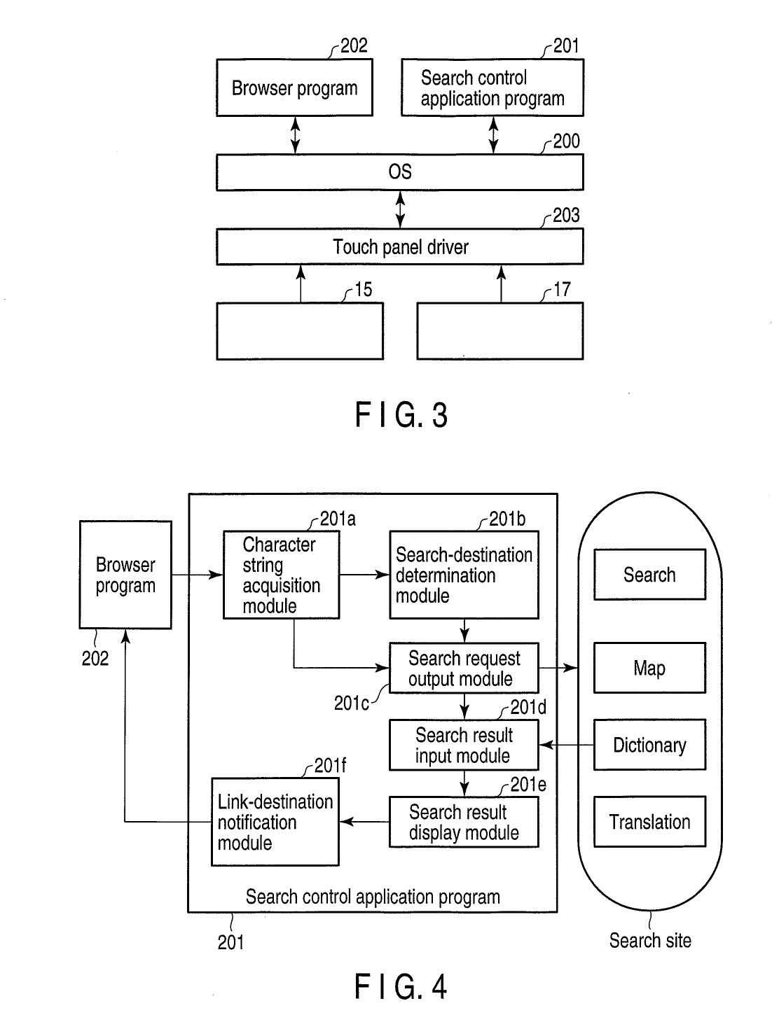

FIG. 3 shows an example of the relationship between programs relating to the touch panels 15 and 17 in the embodiment. In the example of FIG. 3, the user's operations on the touch panels 15 and 17 are controlled by the touch panel driver 203. Alternatively, the same control may be executed by the OS 200 or application program.

The touch panels 15 and 17 are controlled by the touch panel driver 203. The touch panel driver 203 detects contact on the touch panel 15, 17 by an operation using the user's fingertip or pen, thereby detecting coordinate data of the contact position. When the touch panel 15, 17 is touched at a plurality of positions at the same time, the touch panel driver 203 can detect the coordinate data of the plural positions.

The OS 200 and application program (character string display program such as search control application program 201 or browser program 202) execute processes corresponding to the operation on the touch panel 15, 17, which has been detected by the touch panel driver 203. The OS 200 manages display positions of objects (icons representing folders and files, menus, buttons, display windows of respective applications, etc.) which are displayed on the LCD 14, 16. In response to an inquiry from the touch panel driver 203, the OS 200 can make notification as to whether an object is present at a contact position on the touch panel 15, 17, which is detected by the touch panel driver 203. In addition, the browser program 202 has a function of determining an object (character or image), etc., which is designated by the user's operation on the screen displayed on the LCD 14.

Besides, the OS 200 and application programs can execute a process based on the coordinate data of plural positions which are touched on the touch panel 15, 17 at the same time.

FIG. 4 is an exemplary block diagram showing the functional structure of the search control application program 201 in the embodiment. The search control application program 201 displays a search window (second screen) which is independent from a browser screen (first screen) by the browser program 202, and executes, in cooperation with the browser program 202, control to make a screen, which displays a search result, different from a screen on which a user operation is performed for selecting an object (keyword) which is a search target.

In the description below, it is assumed that a user operation for selecting an object (keyword) which is a search target is performed on the browser screen by the browser program 202. Alternatively, an operation for selecting a character string (keyword) which is a search target may be performed on the screen displayed by some other application program (character string display program) which displays a character string.

As shown in FIG. 4, the functions of a character string acquisition module 201a, a search-destination determination module 201b, a search request output module 201c, a search result input module 201d, a search result display module 201e and a link-destination notification module 201f are realized by executing the search control application program 201 by the CPU 111.

The character string acquisition module 201a acquires, as a search keyword for a search engine, an object which is designated by a user operation on the screen displayed by the browser program 202. In this example, character information (character string comprising one or more characters), which is selected from a passage displayed on the browser screen, is acquired.

The search-destination determination module 201b displays, on the second screen, buttons for selecting one of a plurality of search engines, etc., and determines a search engine, for instance, which is a search request destination, in accordance with the user's operation on the button. The search-destination determination module 201b can not only determine a search request destination by the button operation, but also can automatically determine a search request destination in accordance with the kind of object designated by the user on the first screen which is displayed by the browser program 202.

The search request output module 201c outputs a search request for the character information, which is acquired by the character string acquisition module 201a, to a search site, for instance, which is the search request destination determined by the search-destination determination module 201b. In the search control application program 201, a plurality of search sites, etc., which are search request destinations, are set. For example, the search request destinations include a search engine site for searching a site by using a character string as a keyword, a map site for searching a map on the basis of a character string indicative of an address or the like, a dictionary site for searching a dictionary for a designated keyword, and a translation site for converting a character string, which is a keyword, to a character string of another language. A search request may be output, not only to search sites which are made public on the Internet, but also to a search function provided in the personal computer, or another specific information processing apparatus (e.g. server).

The search result input module 201d inputs a result of a search by the search site in connection with the search request which is output by the search request output module 201c. Search results by the search sites include, for example, a list of sites relating to the character information designated as the search keyword, and other associated information.

The search result display module 201e displays the search result which is input by the search result input module 201d.

The link-destination notification module 201f notifies the browser program 202 of an access destination, when information indicative of the access destination is set on the object (character, image, etc.) designated by the user operation in the search result displayed on the LCD 16 (second screen) by the search result display module 201e. The information indicative of the access destination is, for instance, a URL (uniform resource locator) or a file name. The browser program 202 accesses the access destination which is notified by the link-destination notification module 201f, acquires information from the access destination, and displays the information on the LCD 14 (first screen).

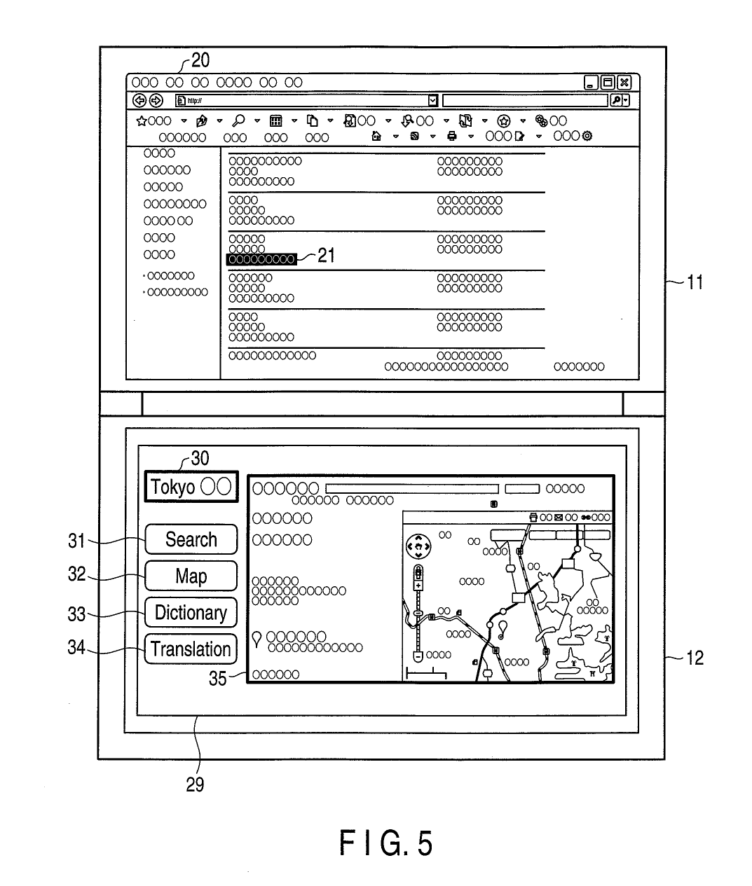

FIG. 5 shows a display example in a case where the search control application program 201 and browser program 202 in the embodiment are executed.

The browser program 202 displays a browser screen 20 on the LCD 14 of the first display unit 11. In FIG. 5, “∘ ∘ ∘” represents a character string. The browser screen 20 displays contents including information such as characters and images described by HTML (Hyper Text Markup Language), etc.

In addition, the search control application program 201 displays a search window 29 on the LCD 16 of the second display unit 12. The search window 29 is provided with a search word input region 30 to which a character string that is a search target can be input by a user operation, search engine select buttons 31, 32, 33 and 34 corresponding to a plurality of search request destinations (search sites), and a search result display region 35. Like the browser program 202, the search control application program 201 displays contents described by HTML, etc., on the search result display region 35.

Next, the operation of the personal computer 10 in the embodiment is described.

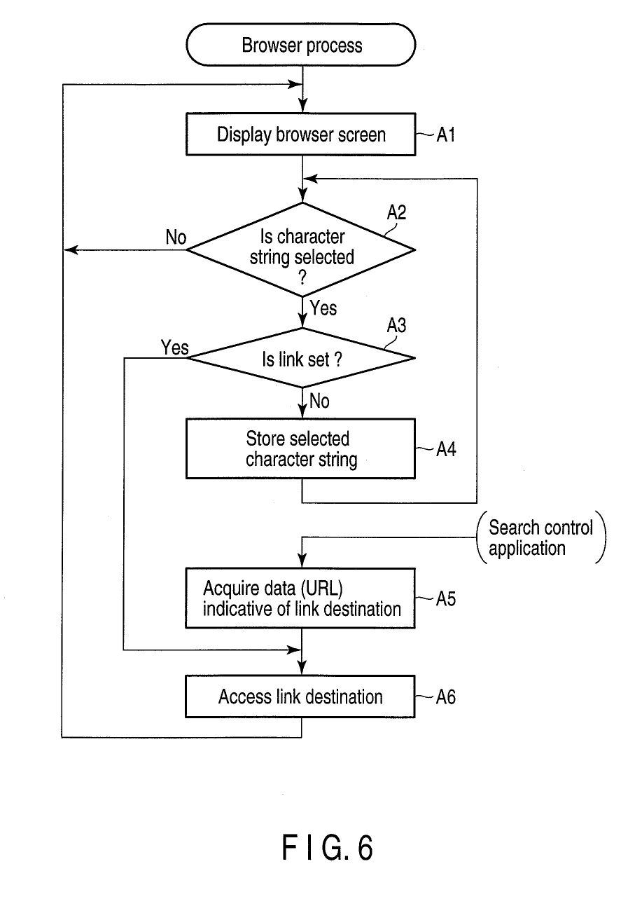

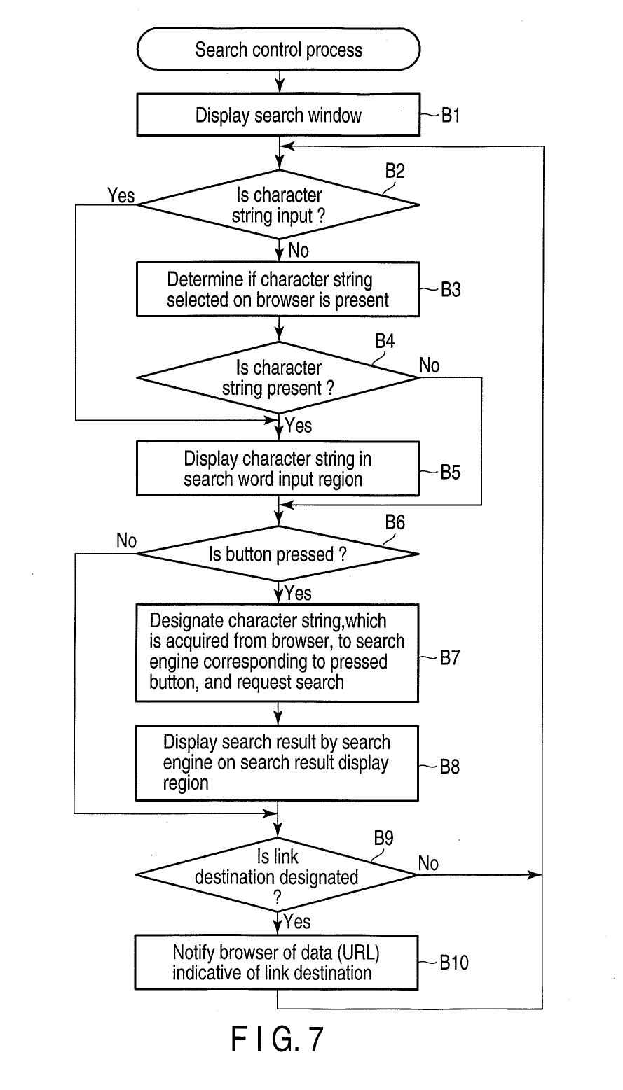

FIG. 6 is an exemplary flow chart illustrating a browser process by the browser program 202, and FIG. 7 is an exemplary flow chart illustrating a search control process by the search control application program 201.

In the personal computer 10 of the embodiment, under the control of the OS 200, the browser program 202 displays the screen (first screen) of the LCD 14 (block A1 in FIG. 6), and the search control application program 201 displays the screen (second screen) of the LCD 16, as shown in FIG. 5 (block B1 in FIG. 7).

In the example of FIG. 5, the screen of a site, which has been accessed by the browser program 202, is displayed. It is assumed that a character string has been selected by a user operation on the browser screen 20 (Yes in block A2). If a link is set on the selected character string (Yes in block A3), the browser program 202 accesses the link destination and displays the Web page of the link destination (block A6). Specifically, the same process as with an ordinary Web browser is executed.

On the other hand, it is assumed that a character string, on which no link is set, has been selected by a user operation (e.g. an operation of dragging the range of a character string that is a target) on the browser screen 20 (No in block A3). In this case, in order to deliver the selected character string to the search control application program 201, the browser program 202 stores the selected character string, for example, in a clip board. In addition, for example, as shown in FIG. 5, the browser program 202 reversely displays the selected character string 21.

In the above description, when a link is set on the character string which is selected by the user operation, the same process as with the ordinary Web browser is executed. However, in the same manner as in the case where a link is not set, the selected character string may be delivered to the search control application program 201 and may be accessed by the search control application program 201.

The search control application program 201 determines whether the character string, which is selected by the browser program 202, is present or not (block B3). For example, if a record of data is present in the clip board, the character string acquisition module 201a of the search control application program 201 determines that the selected character string is present, and acquires the character string and displays the character string in the search word input region 30 (block B5).

If any one of the search engine select buttons 31, 32, 33 and 34 is selected (pressed) by the user (block B6), the search-destination determination module 201b determines, for instance, a search site that is the search request destination corresponding to the selected button. The search request output module 201c designates the character string, which is obtained from the browser program 202, to the search site determined by the search-destination determination module 201b, and outputs a search request (block B7). For example, when the button 31 designating a preset search engine has been pressed, the search request is output to the search engine corresponding to the button 31 via the communication module 123.

The search control application program 201 not merely outputs the search request, based on the character string acquired from the browser program 202. When a character string is input by a user operation through a software keyboard, etc. (Yes in block B2), the search control application program 201 can also display the input character string in the search word input region 30 (block B5), and can output the search request to the search engine corresponding to the button selected from the search engine select buttons 31, 32, 33 and 34, in the same manner as described above (block B6, B7).

The search result input module 201d inputs a search result of the search executed by the search engine in response to the search request that is output from the search request output module 201c. The search result display module 201e displays the search result, which has been input by the search result input module 201d, on the search result display region 35 in the search window (block B8).

Specifically, the search result, which has been obtained by using as the keyword the character string selected on the browser screen 20, is displayed on the search result display region 35 which is different from the browser screen 20. Thus, when the user conducts a search by using a search engine with respect to a plurality of different character strings which are displayed on the browser screen 20 by the browser program 202, the user can confirm the search result with respect to each of the character strings, without switching the display of the browser screen 20 to the page of the search engine.

Usually, when a search relating to an arbitrary character string is executed by using a search engine, the following procedure is necessary. To begin with, a character string, which is used as a search keyword, is selected, and the selected character string is copied. Then, the site of the search engine is accessed, and the page of the search engine is opened. The copied character string is pasted in the keyword input field, the search button is clicked, and the execution of the search is requested. Thus, when a search is executed by using the search engine with respect to a plurality of character strings displayed on a certain Web page, the above-described operation needs to be repeatedly executed, while the Web page including the character string that is the search target and the page of the search engine are being switched on the same browser screen.

By contrast, in the search control application program 201 in the embodiment, after the character string is selected on the browser screen 20 that is displayed by the browser program 202, the search result by the search engine can be displayed on the search window 29 (search result display region 35) that is different from the browser screen 20, simply by clicking one of the search engine select buttons 31, 32, 33 and 34 which are provided on the search window 29 and designate the search request destinations.

In addition, in the search control application program 201 in the embodiment, the plural search request destinations can be selectively used by the same operation on the search engine select buttons 31, 32, 33 and 34. Therefore, for example, with respect to one character string, search results by a plurality of different search engines can easily be displayed. For example, in the state in which the search result obtained by executing the search by clicking the button 31 is displayed on the search result display region 35, the character string, which is selected from the browser screen 20, remains displayed in the search word input region 30. By clicking the button 32 next time, the search result by the search engine corresponding to the button 32, which is obtained by using as the search keyword the character string displayed in the search word input region 30, can be displayed on the search result display region 35.

Furthermore, in the search control application program 201 of the embodiment, when the user has performed an operation of selecting an object with respect to the search result displayed on the search result display region 35, the information relating to the object can be displayed on the browser screen 20 by the browser program 202. The search result display region 35 displays as the search result the contents described by ordinary HTML, etc., which can be displayed in the same manner as with the browser program 202.

When a pointing operation by the user has been executed on the search result display region 35, the search control application program 201 determines whether a link is set on an object at the pointed position, such as a character string or an image. If the search control application program 201 determines that a link is set (Yes in block B9 in FIG. 7), the search control application program 201 notifies the browser program 202 of the data indicative of the link destination by the link-destination notification module 201f (block B10). The data indicative of the link destination is, for example, a URL (uniform resource locator) or a file name.

If the browser program 202 acquires the data indicative of the link destination from the search control application program 201 (block A5 in FIG. 6), the browser program 202 accesses the link destination and displays the Web page of the link destination (block A6).

Usually, since a search result by the search engine includes an object on which a plurality of links are set, Web pages of the respective link destinations are opened and compared. When pages of plural link destinations are to be opened on one screen, the following operation needs to be performed. That is, a page of a link destination is opened and confirmed by clicking an object which is included in the search result and on which the link is set, and thereafter the display is returned to the page displaying the search result, and a page of another link destination is opened.

By contrast, in the search control application program 201 in the embodiment, the search result is displayed on the search result display region 35 in the search window 29. The page of the link destination, which has been designated by the user on the search result display region 35, is accessed by the browser program 202, and the page of the link destination is displayed on the browser screen 20. Accordingly, the user can confirm the pages of plural link destinations included in the search result, without switching the search result displayed on the search result display region 35 of the search window 29.

As has been described above, in the personal computer 10 of the embodiment, the search control application program 201 and browser program 202 are executed. Thereby, the search result, which is obtained by, e.g. the search engine by using as the search keyword the character string designated on the browser screen 20, is displayed on the search result display region 35, and the page of the link destination in the search result displayed on the search result display region 35 can be displayed on the browser screen 20. Specifically, the operation screen, on which the user selects an object such as a character string, and the result screen, which displays the search result corresponding to the selected object, can be made independent from each other by the cooperation between the search control application program 201 and browser program 202. Thus, the usability can be improved, thus making easier the comparison between the search results by the search engine and the contents of the pages of the link destinations which are set on the Web page.

In the above description, the character information, which is the search target, is selected from the browser screen displayed by the browser program 202. However, even when character information, which is a search target, is selected from the screen by a character string display program, the search control by the search control application program 201 can be executed in the same manner as described above. In this case, the link-destination notification module 201f notifies the browser program 202, which is running separately from the character string display program, of the data indicative of the link destination, and causes the browser program 202 to access the link destination. The browser program 202 accesses the notified link destination, and displays the received data on the browser screen.

Next, a description is given of a customizing process of the search window 29 by the search control application program 201.

In the above description, the plural search engine select buttons 31, 32, 33 and 34 are provided on the search window 29 that is displayed by the search control application program 201, and the associated search engines, etc. are set on these buttons. Alternatively, by the customizing process, the search request destinations and buttons may be set in accordance with an instruction from the user.

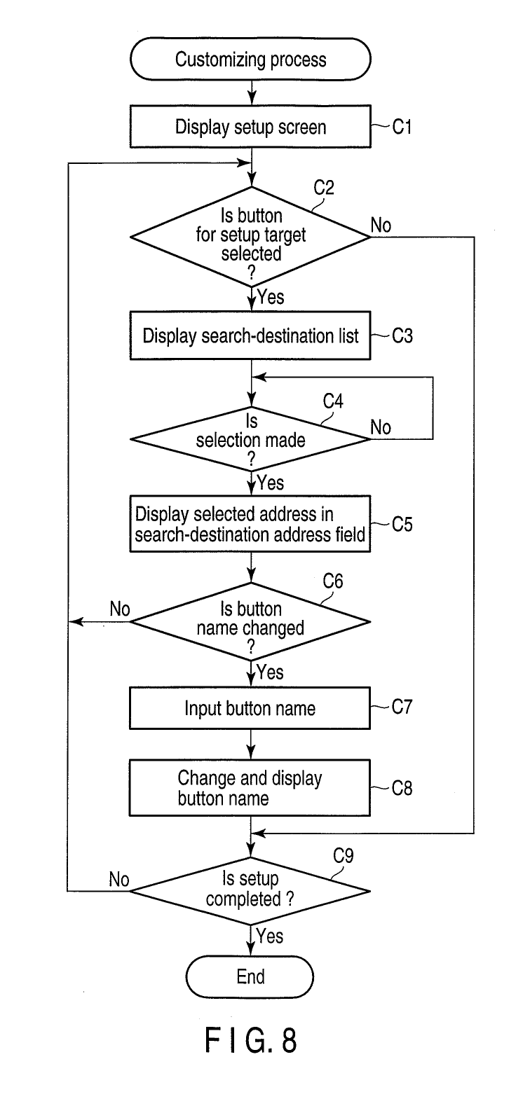

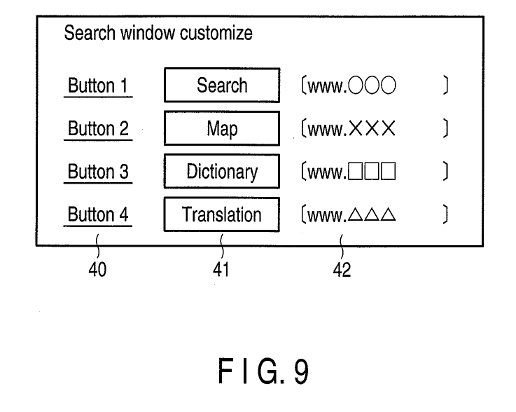

FIG. 8 is an exemplary flow chart illustrating the customizing process by the search control application program 201 in the embodiment. When the execution of the customizing process has been instructed by a predetermined user operation, the search control application program 201 displays a setup screen, as shown in FIG. 9, on the LCD 16 (block C1).

In the setup screen shown in FIG. 9, button display setting regions 41 and search-destination address fields 42 for inputting addresses, etc. of search request destinations are provided in association with button displays 40 indicative of four buttons which are displayed on the search window 29.

If a button, which is a setup target, is selected by the user on the setup screen (block C2), the search control application program 201 displays a search destination list which is prepared in advance on the program side (block C3). In the search destination list, for example, search request destinations (names, addresses, etc.) including search engines, etc. used by many users are registered. If one of the search request destinations (search engines) is selected by the user from the search destination list (Yes in block C4), the search control application program 201 displays the address of the search request destination (search engine), which is selected from the search destination list, on the search-destination address field 42 corresponding to the button selected by the user (block C5).

If the button display setting region 41 is selected and thereby a request for changing the button name is input (Yes in block C6), the search control application program 201 displays an input field for inputting a name of the button and inputs characters of the button name by a user operation using, for example, a software keyboard (block C7). If the input of the button name is determined, the search control application program 201 changes the display of the button display setting region 41 to the button name which has been newly input (block C8).

In the above description, the search request destination is selected from the search destination list. However, some other search request destination, which is not registered in the search destination list, can be set by directly inputting an address of the associated search engine to the search-destination address field 42.

In this manner, with respect to the buttons 1 to 4, button names and search request destinations can arbitrarily be set in accordance with an instruction from the user. If setup completion is instructed (Yes in block C9), the search control application program 201 finishes the customizing process.

As described above, by the customizing process in the embodiment, the user can arbitrarily set search engines, etc. corresponding to the search engine select buttons 31, 32, 33 and 34 which are displayed on the search window 29. Therefore, the user can output a search request for a desired search engine, etc., via the search control application program 201.

In the above description, when any one of the search engine select buttons 31, 32, 33 and 34 is clicked with respect to the character string selected on the browser screen 20, the search request is output to the search engine corresponding to the selected button. Alternatively, an auto-search may be executed to automatically output the search request without the user selecting the search request destination.

In this case, the character string acquisition module 201a acquires the object which is selected by the user on the browser screen 20. For example, the search-destination determination module 201b automatically determines the search request destination in accordance with the kind of the object designated by the user via the browser screen 20. For example, when a character string (word) has been designated from the browser screen 20 by a drag operation or a cursor, the search-destination determination module 201b determines that the dictionary search is the search request destination. The search request output module 201c designates the character string, which has been designated by the user, and outputs the search request to the search request destination which executes a dictionary search.

The user may preset the object that is the target of the auto-search and the search request destination. Thereby, for example, when a character string has been designated, an image associated with this character string may be searched and may automatically be displayed on the search result display region 35, or the character string may be translated into some other language and may be displayed. Thus, even if the button operation by the user is omitted, the search result that is needed by the user can be displayed.

In the above description, the screen of the LCD 14 is displayed by the browser program 202, and the screen of the LCD 16 is displayed by the search control application program 201. However, the LCDs 14 and 16, on which the screens are displayed by the respective programs, may be reversed.

In the above description, the browser program 202 and the search control application program 201 display screens on the LCDs 14 and 16, respectively. Alternatively, process windows (display regions) corresponding to the respective programs may be provided on one of the LCDs 14 and 16, for example, on the LCD 14, and the same process as described above may be executed. Specifically, a search result of a character (string) designated on the first window, which is displayed by the browser program 202, is displayed on the second window by the search control application program 201. In the search result displayed on the second window, if a part on which a link is set is designated by the user, the link destination is accessed by the browser program 202 and is displayed on the first window.

In the above description, the user operation for selecting the object displayed on the LCD 14, 16 is detected by the touch panel 15, 17. Alternatively, other pointing devices (e.g. a mouse) or external keyboards, which are usable in the personal computer, may be used.

The browser program 202 has been described, by way of example, as the application for effecting display on the LCD 14 (first screen). Alternatively, use may be made of an arbitrary application which can select an object, such as a character string, by a user operation.

The process that has been described in connection with the above-described embodiment may be stored, as a search control application program which can be executed by a computer, in a recording medium such as a magnetic disk (e.g. a flexible disk, a hard disk), an optical disk (e.g. a CD-ROM, a DVD) or a semiconductor memory, and may be provided to various apparatuses. The search control application program may be transmitted via communication media and provided to various apparatuses. The computer reads the search control application program that is stored in the recording medium or receives the program via the communication media. The operation of the apparatus is controlled by the program, thereby executing the above-described process.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
an acquisition module configured to acquire information regarding an object designated on a first screen displayed by a program;
an output module configured to output to a search process module a search request relating to the information;
an input module configured to receive a search result by the search process module in connection with the search request; and
a search result display configured to display the search result on a second screen.

2. The apparatus of claim 1, further comprising a determination module configured to determine the search process module, in accordance with a user operation on a button displayed on the second screen.

3. The apparatus of claim 2, wherein the second screen comprises a character input region, and
the output module is configured to output the search request to the search process module with a character input to the character input region.

4. The apparatus of claim 1, wherein the program comprises a browser program, and
the apparatus further comprises a notification module configured to notify an access destination to the browser program based on when information regarding the access destination is included in the search result displayed on the second screen.

5. The apparatus of claim 2, further comprising a setup module configured to set, according to a user operation, search request destinations corresponding to the button.

6. A search control method comprising:
acquiring information regarding an object designated on a first screen displayed by a program;
outputting to a search process module a search request relating to the acquired information;
receiving a search result by the search process module in connection with the search request; and
displaying the search result on a second screen.

7. The method of claim 6, further comprising:
determining the search process module in accordance with a user operation on a button displayed on the second screen.

8. The method of claim 7, wherein the second screen comprises a character input region, and the method further comprises:
outputting the search request to the search process module with a character input to the character input region.

9. The method of claim 6, wherein the program comprises a browser program, and the method further comprises:
notifying an access destination to the browser program based on when information regarding the access destination is included in the search result displayed on the second screen.

10. The method of claim 7, further comprising setting, according to a user operation, search request destinations corresponding to the button.

11. A non-transitory computer readable medium having stored thereon a computer program which is executable by a computer, the computer program controlling the computer to execute functions of:
acquiring information regarding an object designated on a first screen displayed by a program;
outputting to a search process module a search request relating to the acquired information;
receiving a search result by the search process module in connection with the search request; and
displaying the search result on a second screen.

12. The medium of claim 11, wherein the computer program controls the computer to further execute a function of:
determining the search process module in accordance with a user operation on a button displayed on the second screen.

13. The medium of claim 12, wherein the second screen comprises a character input region, and
the computer program controls the computer to execute a function of outputting the search request to the search process module with a character input to the character input region.

14. The medium of claim 11, wherein the program comprises a browser program, and
the computer program controls the computer to further execute a function of notifying an access destination to the browser program when information regarding the access destination is included in the search result displayed on the second screen.

15. The medium of claim 12, wherein the computer program controls the computer to further execute a function of setting, according to a user operation, search request destinations corresponding to the button.
